(19) United States
(12) Patent Application Publication
(10) Pub. No.: US 2017/0142651 A1
(43) Pub. Date: May 18, 2017

(54) Controlling Power Usage

(71) Applicant: TELEFONAKTIEBOLAGET L M ERICSSON (PUBL), Stockholm (SE)

(72) Inventors: Hans Eriksson, Sollentuna (SE); Goran Eriksson, Norrtalje (SE)

(21) Appl. No.: 14/433,527

(22) PCT Filed: Mar. 4, 2015
(86) PCT No.: PCT/SE2015/050244

§ 371 Date: Apr. 3, 2015

(51) Int. Cl. H04W 52/02; H04W 72/04

(52) U.S. Cl. CPC H04W 52/0206; H04W 72/0453; H04W 72/0473; H04W 88/08

(57) ABSTRACT

It is presented a method performed in a power control device for controlling power usage. The method comprises the steps of: determining a power command to be transmitted to a radio base station; generating the power command for the radio base station; and causing the power command to be appended to data packet bound for the radio base station.

### TECHNICAL FIELD

The invention relates to a method, power control device, computer program and computer program product for controlling power usage in one or more radio base stations.

### BACKGROUND

Cellular communication networks comprise a lot of power consuming components. The radio access network, comprising all radio base stations is a major consumer of power for an operator of the cellular communication network.

Today, power consumption represents about a quarter of the cost for operating a cellular communication network. With the event of internet of things and the need to improve indoor coverage for many more connected devices, the power requirements of cellular communication networks will only increase.

The cost of power for operator in many markets is a function of the actual consumption, but also whether it is a predicted need of power or not; the price of electricity on the spot market is considerably higher than the agreed price for a business agreement.

### SUMMARY

It is an object to provide a tool to allow an operator of a cellular communication network to avoid sudden surges in power consumption.

According to a first aspect, it is presented a method performed in a power control device for controlling power usage. The method comprises the steps of: determining a power command to be transmitted to a radio base station; generating the power command for the radio base station; and causing the power command to be appended to data packet bound for the radio base station. By providing power commands by appending the command to a data packet, a convenient mechanism for power control is provided. This allows the power control to occur frequently when needed (typically when data load is high, i.e. when a lot of data packets are transmitted).

The step of determining a power command may comprise determining a power command to reduce power usage in a time period when a threshold power usage is otherwise estimated to be exceeded.

The method may be repeated, in which the step of determining a power command comprises determining a power command to increase power usage in a time period when such an increase does not risk exceeding the threshold power usage.

The step of determining a power command may comprise determining a power command to command the radio base station to manage its own power usage.

The step of determining a power command may comprise determining one or more power commands such that power usage in a plurality of radio base stations should be modified. In such a case, the steps of generating and causing are performed for each one of the plurality of radio base stations.

The step of determining a power command may comprise evaluating a combined power usage of the plurality of radio base stations.

The step of determining a power command may comprise determining a power command such that a macro cell is to be active and that one or more pico cells, whose coverage forms part of a coverage of the macro cell, is to be deactivated.

The method may be repeated for each data packet to a radio base station.

The step of determining a power command may comprise determining a power command to deactivate the radio base station.

The step of determining a power command may comprise determining a power command indicating a maximum amount of power which the radio base station is allowed to use.

The step of determining a power command may comprise determining a power command comprising computer code for managing power usage in the radio base station.

The step of determining a power command may comprise determining a power command comprising a frequency band and a frequency bandwidth to be used by the radio base station.

The step of causing may comprise causing the power command to be appended a data packet bound for the radio base station in a user plane.

According to a second aspect, it is presented a power control device for controlling power usage. The power control device comprises: a processor; and a memory storing instructions that, when executed by the processor, causes the power control device to: determine a power command to be transmitted to a radio base station; generate a power command for the radio base station; and cause the power command to be appended to data packet bound for the radio base station.

The instructions to determine a power command may comprise instructions that, when executed by the processor, causes the power control device to determine a power command to reduce power usage in a time period when a threshold power usage is otherwise estimated to be exceeded.

The method may be repeated, in which case the instructions to determine a power command comprise instructions that, when executed by the processor, causes the power control device to determine a power command to increase power usage in a time period when such an increase does not risk exceeding the threshold power usage.

The instructions to determine a power command may comprise instructions that, when executed by the processor, causes the power control device to determine a power command to command the radio base station to manage its own power usage.

The instructions to determine may comprise instructions that, when executed by the processor, causes the power control device to determine that power usage in a plurality of radio base stations should be modified. In such a case, the instructions further comprise instructions that, when executed by the processor, causes the power control device to perform the instructions to generate, and cause for each one of the plurality of radio base stations.

The instructions to determine a power command may comprise instructions that, when executed by the processor, causes the power control device to evaluate a combined power usage of the plurality of radio base stations.

The instructions to determine a power command may comprise instructions that, when executed by the processor, causes the power control device to determine a power command such that a macro cell is to be active and that one or more pico cells, whose coverage forms part of a coverage of the macro cell, is to be deactivated.

The power command may comprise a command to deactivate the radio base station.

The power command may comprise a command indicating a maximum amount of power which the radio base station is allowed to use.

The power command may comprise computer code for managing power usage in the radio base station.

The power command may comprise a frequency band and a frequency bandwidth to be used by the radio base station.

The instructions to cause may comprise instructions that, when executed by the processor, causes the power control device to cause the power command to be appended a data packet bound for the radio base station in a user plane.

According to a third aspect, it is presented a power control device comprising: means for determining a power command to be transmitted to a radio base station; means for generating the power command for the radio base station; and means for causing the power command to be appended to data packet bound for the radio base station.

According to a fourth aspect, it is presented a computer program for controlling power usage. The computer program comprises computer program code which, when run on a power control device causes the power control device to: determine a power command to be transmitted to a radio base station; generate a power command for the radio base station; and cause the power command to be appended to data packet bound for the radio base station.

According to a fifth aspect, it is presented a computer program product comprising a computer program according to the fourth aspect and a computer readable means on which the computer program is stored.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated.

### BRIEF DESCRIPTION OF THE DRAWINGS

The invention is now described, by way of example, with reference to the accompanying drawings, in which:

FIG. 1 is a schematic diagram illustrating an environment in which embodiments presented herein can be applied;

FIG. 2 is a schematic diagram illustrating a control plane and a user plane for use in the environment of FIG. 1;

FIGS. 3A-C are flow charts illustrating methods for controlling power usage;

FIG. 4 is a schematic diagram illustrating components of a power control device capable of performing one or more of the methods illustrated in FIGS. 3A-C;

FIG. 5 is a schematic diagram showing functional modules of the power control device of FIG. 4 according to one embodiment; and

FIG. 6 shows one example of a computer program product comprising computer readable means.

### DETAILED DESCRIPTION

The invention will now be described more fully hereinafter with reference to the accompanying drawings, in which certain embodiments of the invention are shown. This invention may, however, be embodied in many different forms and should not be construed as limited to the embodiments set forth herein; rather, these embodiments are provided by way of example so that this disclosure will be thorough and complete, and will fully convey the scope of the invention to those skilled in the art. Like numbers refer to like elements throughout the description.

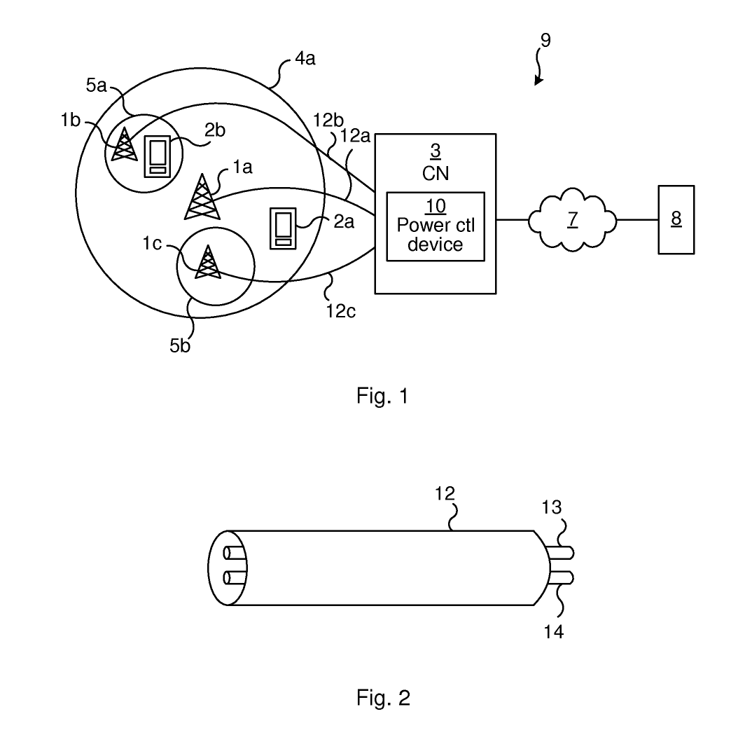

FIG. 1 is a schematic diagram illustrating a cellular communication network 9 where embodiments presented herein may be applied. The cellular communication network 9 comprises a core network 3 and radio base stations 1, here in the form of radio base stations being evolved Node Bs, also known as eNode Bs or eNBs. The radio base station 1 could also be in the form of Node Bs, BTSs (Base Transceiver Stations) and/or BSSs (Base Station Subsystems), etc. The radio base station 1 provides radio connectivity over a wireless interface to a plurality of wireless terminals 2a-b. The term wireless terminal is also known as mobile communication terminal, user equipment (UE), mobile terminal, user terminal, user agent, wireless device, machine-to-machine device etc., and can be, for example, what today are commonly known as a mobile phone, smart phone or a tablet/laptop with wireless connectivity. The term wireless is here to be construed as having the ability to perform wireless communication. More specifically, the wireless terminals 2a-b can comprise a number of wires for internal and/or external purposes.

The cellular communication network 9 may e.g. comply with any one or a combination of LTE (Long Term Evolution), W-CDMA (Wideband Code Division Multiplex), EDGE (Enhanced Data Rates for GSM (Global System for Mobile communication) Evolution), GPRS (General Packet Radio Service), CDMA2000 (Code Division Multiple Access 2000), or any other current or future wireless network, such as LTE-Advanced, and future fifth generation networks as long as the principles described hereinafter are applicable.

Over the wireless interface, uplink (UL) communication occurs from a wireless terminal to a radio base station and downlink (DL) communication occurs from a radio base station to a wireless terminal. The quality of the wireless radio interface to each wireless terminal can vary over time and depending on the position of the wireless terminal, due to effects such as fading, multipath propagation, interference, etc. In the example of FIG. 1, a first radio base station ia is used for a macro cell 4, providing coverage in a relatively large area. A second radio base station 1b provides coverage in its pico cell 5a, which is a smaller cell contained in the macro cell 4. Analogously, a third radio base station 1c provides coverage in its pico cell 5b, which is thus also a smaller cell contained in the macro cell 4. Hence the first wireless terminal 2a is in a position where it is covered only by the macro cell 4. On the other hand, the second wireless terminal 2b is in a position where it can gain coverage using either the first pico cell 5a or the macro cell 4.

The first radio base station 1a is connected to the core network 3 via a first connection 12a, e.g. over an S1 interface in LTE or an Iu interface in W-CDMA. The second radio base station 1b is connected to the core network 3 via a second connection 12b, e.g. over an S1 interface in LTE or an Iu interface in W-CDMA. The third radio base station 1c is connected to the core network 3 via a third connection 12C, e.g. over an S1 interface in LTE or an Iu interface in W-CDMA. It is to be noted that any suitable number of radio base stations can be provided in the cellular communication network 9; the number of radio base stations shown in FIG. 1 is only an example.

The core network 3 comprises a power control device 10 which controls power usage in the radio base stations 1a-c using power commands. The radio base stations 1a-c then control power in detail, while complying with power commands from the power control device 10. In this way, the power control device io can control power usage of all radio base stations 1a-c of the cellular communication network 9, e.g. to comply with an overall power threshold.

Power control options in the prior art concerns power regulation is controlled io by each radio access point (e.g. radio base station) without considering the operators total network usage. This has proved to be satisfactory as long as spectrum utilisation is the most important factor and there is no requirements of control of sustainable power consumption. However, the total used power consumption in a mobile network is high and power consumption variation varies over time (including site infrastructure, hardware nodes, cooling etc.).

In other words, in the prior art, power usage in cellular communication networks is focused on obtaining maximum throughput per hertz in the network, where radio spectrum has been the primary scarce resource. In the future, networks will be deployed more densely with significantly more bandwidth available, due to frequency reuse and also due increased use of unlicensed and shared spectrum resources. Hence, throughput optimisation will decrease from its current paramount importance, allowing a reduction of power usage to be achieved.

The core network 3 also provides connectivity to other central functions and a wide area network 7, such as the Internet. One or more application servers 8 are also connected to the wide area network 7.

FIG. 2 is a schematic diagram illustrating a connection with a control plane and a user plane for use in the environment of Fig 1. Each one of the connections 12a-c of FIG. 1 is here represented by a single connection 12. The connection 12 comprises a user plane 13 and a control plane 14. Data packets are sent in the user plane 13 and control packets are send in the control plane 14. As will be explained in more detail below, power commands are transmitted from the power control device to radio base stations by appending data packets in the user plane 13.

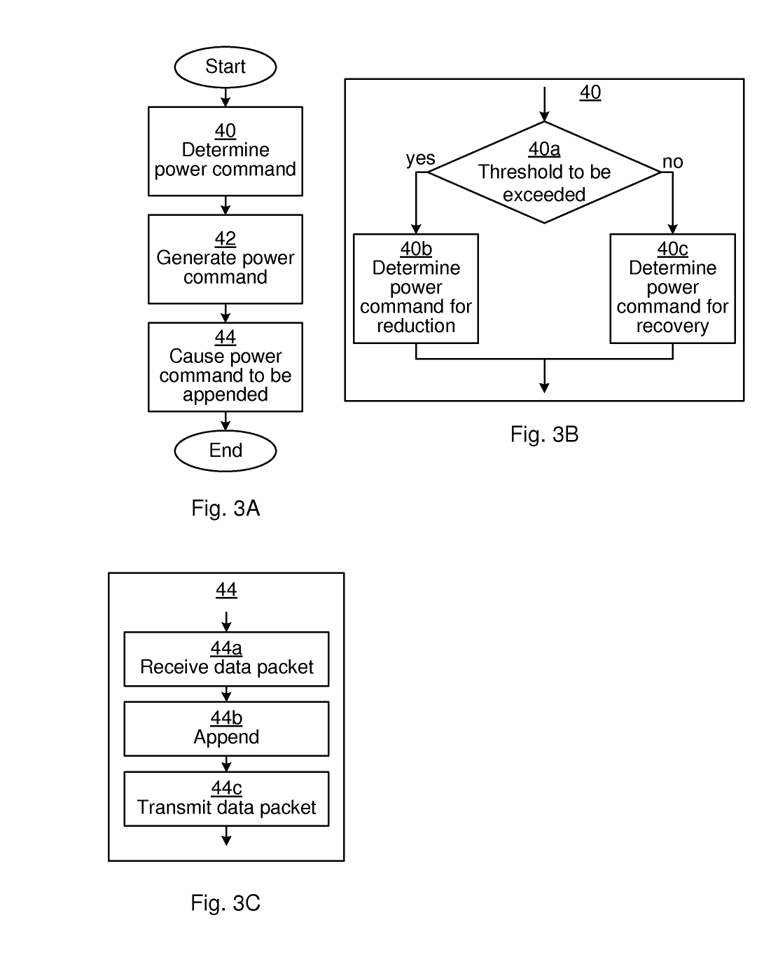

FIGS. 3A-C are flow charts illustrating methods for controlling power usage. The method is performed in the power control device. First, the method illustrated in FIG. 3A will be described.

In a determine power command step 40, a power command is determined to be transmitted to a radio base station. The power command is selected to achieve a desired effect at the radio base station in terms of power usage for downlink transmissions.

This determination can be based on analysis of traffic statistics. The statistics can be collected based on all users, traffic demands, mobility pattern and total use of power consumption over time (minutes, hours, days, weeks . . . ). The statistics can be collected for the whole cellular communication network, on a radio base station granularity if desired. The statistics is used in predicting future traffic and effects of different power control strategies. It is a goal to balance network power usage and traffic effect. By controlling the power to a stable and predictable level, the operator can reduce power usage and achieve more favourable contracts with power suppliers. Other input for analysis of network status can also be used, for example: time schedules for maintenance, known public events that will cause more traffic demands, network errors, disturbances in traffic etc.

In one example, the power command indicates to the radio base station to manage its own power usage. This is a hands-off approach and can be used when power control on an aggregate level from the power control device 10 is not needed anymore.

In one example, one or more power commands are determined such that power usage in a plurality of radio base stations should be modified. In other words, one or more power commands are generated for each radio base station for which the power usage should be modified. This can e.g. be determined by evaluating a combined power usage of the plurality of radio base stations and comparing with goals of power usage.

In one example, a power command is determined for such that a macro cell is to be active and that one or more pico cells, whose coverage forms part of a coverage of the macro cell, is to be deactivated. This would then result in a power command to each one of the radio base stations for the one or more pico cells to be deactivated. Optionally, this also includes determining a power command for a radio base station of the macro cell to be active.

In one example, a power command is determined to deactivate the radio base station. This reduces the power usage for the radio base station to a minimum. This alternative switches off the radio base station e.g. in low traffic hours for that area, especially for pico cells which are otherwise covered by a macro cell. The low traffic hours can be predicted by analysing statistics of traffic usage.

In one example, a power command is determined which indicates a maximum amount of power which the radio base station is allowed to use, i.e. a power budget. In this way, a power usage cap is indicated, but the radio base station is allowed to use less power if this is appropriate. The power budget is a measure to control how much energy can be transmitted by the radio base station and can also be used to determine if there is radio congestion, i.e. there is more data to transmit than what radio base station is capable of, resulting in data buffering in the system. This results in a delay and lower throughput for the end user application. The power budget reduces transmission power and thus also reduces power usage for cooling. By estimating congestion (e.g. using traffic statistics) prior to determining the power budget power command, a suitable balance between power saving and negative effects can be achieved.

In one example, a power command is determined which comprises computer code for managing power usage in the radio base station. In this way, the power control device can provide arbitrary logic to the radio base station, whereby the power control device has great power over the power usage in the radio base station. The computer program code can be compiled computer program code (e.g. from C, C++ of Java) or it can be script-based computer program code (e.g. JavaScript using JSON (JavaScript Object Notation)).

In one example, a power command is determined which comprises a frequency band and a frequency bandwidth to be used by the radio base station. This is an efficient way of controlling power usage by the radio base station. This can be used e.g. in low traffic demand periods, where the lowest power consumption technology and frequency band usage can be used for selected cells in the network. For the frequency bandwidth, a more narrow bandwidth requires less transmission power. Using this power command may also require cell replanning of the network to minimize negative impacts, also based on traffic statistics.

In a generate power command step 42, the power command is generated for the radio base station. This involves creating the power command according to what was determined in the determine power command step 40. Optionally, the determine power command step 40 and the generate power command step 42 are performed in parallel.

In a cause power command to be appended step 44, the power control device causes the power command to be appended to data packet bound for the radio base station. This can involve sending the power command to a node which appends the power command to the data packet bound for the radio base station. Alternatively, the power control device performs the appending itself, as illustrated in FIG. 3C and explained in more detail below.

This step can cause the power command to be appended a data packet bound for the radio base station in a user plane (see 13 of FIG. 2).

When the power commands are for a plurality of radio base stations, the generate power command step 42 and the cause power command to be appended step 44 are performed (sequentially or in parallel) for each one of the plurality of radio base stations.

The method may be repeated for each data packet to a radio base station.

Alternatively, the method is repeated but not as often as for each data packet. Alternatively, the determine power command step 40 is repeated often and whenever a new power command is determined, the remaining steps are performed to transmit the new power command to the radio base station(s).

By appending the power command to the data packet, a very fine granularity of control is achieved. Such a mechanism allows the power control device to control power usage in the radio base station per individual traffic flow. Moreover, the granularity in time is great, since the power commands can be transmitted with each data packet.

Looking now to FIG. 3B, an embodiment of the determine power command step 40 of FIG. 3A will be described. Here, the determine power command step 40, in turn, comprises three steps.

In a conditional threshold to be exceeded step 40a, it determined whether a threshold power usage is at the risk of being exceeded with a current power scheme, e.g. by evaluating a combined power usage of a plurality of radio base stations. When the threshold power usage is at risk of being exceeded, the method proceeds to a determine power command for reduction step 40b. Otherwise, the method proceeds to a determine power command for recovery step 40c.

In the determine power command for reduction step 40b, a power command is determined to reduce power usage in a time period when the threshold power usage is estimated to be exceeded. The reduced power can imply increased traffic buffers, increasing delay for traffic.

In the determine power command for recovery step 40c, a power command is determined to increase power usage in a time period when such an increase does not risk exceeding the threshold power usage. The increase in power is calculated such that the threshold power is not exceeded by when the increase is effected. In this step, by increasing the power, the radio base station can provide greater throughput and thus recover from a previous power reduction phase. The recovery can then result in reduced traffic buffers.

Looking now to FIG. 3C, an embodiment of the cause power command to be appended step of FIG. 3A will be described. Here, the cause power command to be appended step 44, in turn, comprises three steps.

In a receive data packet step 44a, a data packet is received. The data packet is a data packet in the user plane bound for the radio base station for which a power command is to be communicated.

In an append step 44b, the power command for the radio base station is appended to the data packet. This results in a modified data packet. For instance, the metadata can be appended by encapsulating the data of the data packet in the modified data packet. The modified data packet can then comprise both the original data packet in amended (or amended) form and the power command. The encapsulation can e.g. utilise a tunnel protocol such as GTP (GPRS Tunnelling Protocol).

In a transmit data packet step 44c, the modified data packet is transmitted to the radio base station in question, in the user plane.

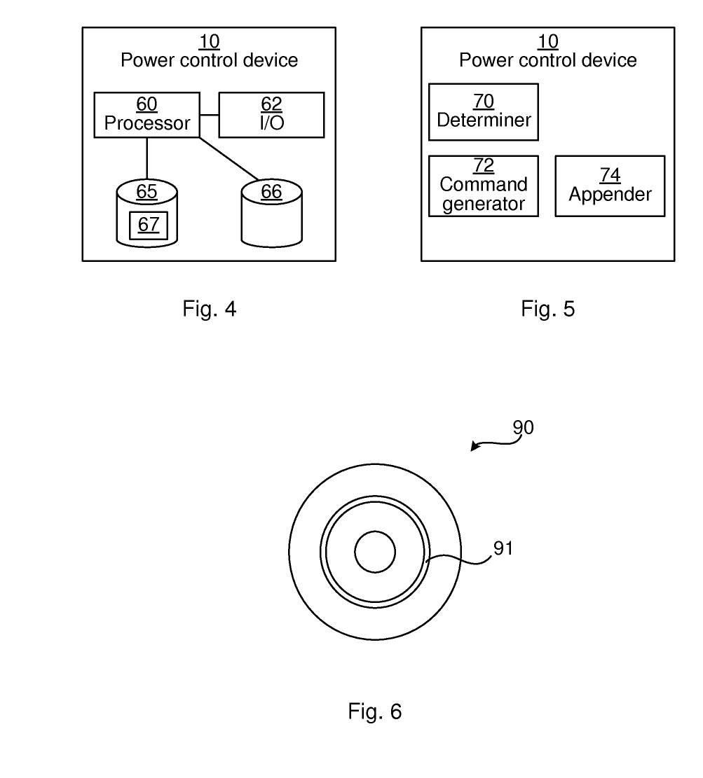

FIG. 4 is a schematic diagram illustrating components of a power control device capable of performing one or more of the methods illustrated in FIGS. 3A-C. The power control device may be provided in host device also performing other functions. In such a case, one or more of the components of FIG. 4 may be shared with the host device.

A processor 60 is provided using any combination of one or more of a suitable central processing unit (CPU), multiprocessor, microcontroller, digital signal processor (DSP), application specific integrated circuit etc., capable of executing software instructions 67 stored in a memory 65, which can thus be a computer program product. The processor 60 can be configured to execute the method described with reference to FIGS. 3A-C above.

The memory 65 can be any combination of read and write memory (RAM) and read only memory (ROM). The memory 65 also comprises persistent storage, which, for example, can be any single one or combination of magnetic memory, optical memory, solid state memory or even remotely mounted memory.

A data memory 66 is also provided for reading and/or storing data during execution of software instructions in the processor 60. The data memory 66 can be any combination of read and write memory (RAM) and read only memory (ROM).

The power control device 10 further comprises an I/O interface 62 for communicating with other external entities such as radio base stations and other core network nodes. Optionally, the I/O interface 62 also includes a user interface.

Other components of the power control device 10 are omitted in order not to obscure the concepts presented herein.

FIG. 5 is a schematic diagram showing functional modules of the power control device of FIG. 4 according to one embodiment. The modules are implemented using software instructions such as a computer program executing in the power control device. The modules correspond to the steps in the methods illustrated in FIGS. 3A-C.

A determiner 70 is configured to determine a power command to be transmitted to a radio base station. This module corresponds to the determine power command step 40 of FIG. 3A and all of the steps of FIG. 3B.

A command generator 72 is configured to generate a power command for the radio base station. This module corresponds to the generate power command step 42 of FIG. 3A.

An appender 72 is configured to cause the power command to be appended to data packet bound for the radio base station. This module corresponds to the cause power command to be appended step 44 of FIG. 3A and all the steps of FIG. 3C.

FIG. 6 shows one example of a computer program product comprising computer readable means. On this computer readable means a computer program 91 can be stored, which computer program can cause a processor to execute a method according to embodiments described herein. In this example, the computer program product is an optical disc, such as a CD (compact disc) or a DVD (digital versatile disc) or a Blu-Ray disc. As explained above, the computer program product could also be embodied in a memory of a device, such as the computer program product 65 of FIG. 4. While the computer program 91 is here schematically shown as a track on the depicted optical disk, the computer program can be stored in any way which is suitable for the computer program product, such as a removable solid state memory, e.g. a Universal Serial Bus (USB) drive.

The invention has mainly been described above with reference to a few embodiments. However, as is readily appreciated by a person skilled in the art, other embodiments than the ones disclosed above are equally possible within the scope of the invention, as defined by the appended patent claims.

1-28. (canceled)

29. A method performed in a power control device for controlling power usage, the method comprising the steps of:
determining a power command to be transmitted to a radio base station;
generating the power command for the radio base station; and
causing the power command to be appended to a data packet bound for the radio base station.

30. The method of claim 29, wherein the step of determining a power command comprises determining a power command to reduce power usage in a time period when a threshold power usage is otherwise estimated to be exceeded.

31. The method of claim 30, wherein said determining, generating, and causing are repeated, and wherein determining a power command comprises determining a power command to increase power usage in a time period when such an increase does not risk exceeding the threshold power usage.

32. The method of claim 29, wherein determining a power command comprises determining a power command to command the radio base station to manage its own power usage.

33. The method of claim 29, wherein determining a power command comprises determining one or more power commands such that power usage in a plurality of radio base stations should be modified; and wherein said generating and causing are performed for each one of the plurality of radio base stations.

34. The method of claim 33, wherein determining a power command comprises evaluating a combined power usage of the plurality of radio base stations.

35. The method of claim 33, wherein determining a power command comprises determining a power command such that a macro cell is to be active and that one or more pico cells, whose coverage forms part of a coverage of the macro cell, is to be deactivated.

36. The method of claim 29, wherein said determining, generating, and causing is repeated for each data packet to a radio base station.

37. The method of claim 29, wherein determining a power command comprises determining a power command to deactivate the radio base station.

38. The method of claim 29, wherein determining a power command comprises determining a power command indicating a maximum amount of power which the radio base station is allowed to use.

39. The method of claim 29, wherein determining a power command comprises determining a power command comprising computer code for managing power usage in the radio base station.

40. The method of claim 29, wherein determining a power command comprises determining a power command comprising a frequency band and a frequency bandwidth to be used by the radio base station.

41. The method of claim 29, wherein said causing comprises causing the power command to be appended to a data packet bound for the radio base station in a user plane.

42. A power control device for controlling power usage, the power control device comprising:
a processor; and
a memory storing instructions that, when executed by the processor, cause the power control device to:
determine a power command to be transmitted to a radio base station;
generate a power command for the radio base station; and
cause the power command to be appended to data packet bound for the radio base station.

43. The power control device of claim 42, wherein the instructions to determine a power command comprise instructions that, when executed by the processor, causes the power control device to determine a power command to reduce power usage in a time period when a threshold power usage is otherwise estimated to be exceeded.

44. The power control device of claim 43, wherein the instructions comprise instructions to repeat the determining, generating, and causing, and wherein the instructions to determine a power command comprise instructions that, when executed by the processor, cause the power control device to determine a power command to increase power usage in a time period when such an increase does not risk exceeding the threshold power usage.

45. The power control device of claim 42, wherein the instructions to determine a power command comprise instructions that, when executed by the processor, cause the power control device to determine a power command to command the radio base station to manage its own power usage.

46. The power control device of claim 42, wherein the instructions to determine comprise instructions that, when executed by the processor, cause the power control device to determine that power usage in a plurality of radio base stations should be modified; and further comprising instructions that, when executed by the processor, cause the power control device to perform the instructions to generate, and cause for each one of the plurality of radio base stations.

47. The power control device of claim 46, wherein the instructions to determine a power command comprise instructions that, when executed by the processor, cause the power control device to evaluate a combined power usage of the plurality of radio base stations.

48. The power control device of claim 46, wherein the instructions to determine a power command comprise instructions that, when executed by the processor, cause the power control device to determine a power command such that a macro cell is to be active and that one or more pico cells, whose coverage forms part of a coverage of the macro cell, is to be deactivated.

49. The power control device of claim 42, wherein the power command comprises a command to deactivate the radio base station.

50. The power control device of claim 42, wherein the power command comprises a command indicating a maximum amount of power which the radio base station is allowed to use.

51. The power control device of claim 42, wherein the power command comprises computer code for managing power usage in the radio base station.

52. The power control device of claim 42, wherein the power command comprises a frequency band and a frequency bandwidth to be used by the radio base station.

53. The power control device of claim 42, wherein the instructions to cause comprise instructions that, when executed by the processor, cause the power control device to cause the power command to be appended a data packet bound for the radio base station in a user plane.

54. A power control device comprising:
means for determining a power command to be transmitted to a radio base station;
means for generating the power command for the radio base station; and
means for causing the power command to be appended to data packet bound for the radio base station.

55. A non-transitory computer-readable medium comprising, stored thereupon, a computer program for controlling power usage, the computer program comprising computer program code that, when run on a power control device, causes the power control device to:
determine a power command to be transmitted to a radio base station;
generate a power command for the radio base station; and
cause the power command to be appended to data packet bound for the radio base station.
